(19) United States
(12) Patent Application Publication
(10) Pub. No.: US 2004/0098260 A1
(43) Pub. Date: May 20, 2004

(54) Compact talking personal environmental status device

(76) Inventor: Richard B. Sharpe, Woodridge, IL (US)

Correspondence Address: LATHROP & GAGE LC, 4845 PEARL EAST CIRCLE, SUITE 300, BOULDER, CO, 80301, US

(21) Appl. No.: 10/600,069

(22) Filed: Jun. 20, 2003

Related U.S. Application Data
(60) Provisional application No. 60/390,557, filed on Jun. 21, 2002.

(51) Int. Cl. G10L 13/00

(52) U.S. Cl. 704/258

(57) ABSTRACT

A compact instrument primarily for indicating ambient temperature on clothing or baggage. Just press the button and the unit will speak and tell you the temperature. Features include replaceable Lithium battery for cold weather operation below −20c. The instrument can be used on jackets, baggage, brief cases, computer bags, sport bags, or back packs; it can also be used as a key chain. The instrument can also be adapted to talk in synthetic speech of air pressure, humidity, wind, wind-chill, UV readings, x-ray readings, dust particles, radon gas, carbon monoxide and/or most other environmental conditions. The primary form of this instrument is small and compact, and can be used as a zipper pull for a parka or jacket. It houses a printed circuit board with batteries, or battery, speaker, speech synthesizer and microprocessor. No visual indication is present to the user, only audio information on the environment being sensed. The microprocessors can be set up for any specific limits to announce to the user of a condition.

### RELATED APPLICATIONS

This application claims priority to U.S. Provisional Application No. 60/390,557, filed Jun. 21, 2002, which is expressly incorporated herein by reference.

### BACKGROUND

Human interest in the environment has increased throughout the ages as more environmental concerns have emerged. Monitoring and informing of environmental conditions is desirable—such as to advise of temperature, humidity, wind, barometric pressure, wind-chill, UV radiation, x-ray radiation, carbon monoxide, radon gas, dust particles, and other environmental elements—so that a person may take proper precautions to optimize his or her interaction with the environment. Existing environmental sensors provide information about the environment, but are cumbersome and difficult to use.

### SUMMARY OF THE INVENTION

A small printed circuit board, battery, voice synthesizer and enclosure form a device that is attachable to luggage, clothing, baggage, backpacks, briefcases and/or key chains. The user presses a button and an environmental characteristic is digitally “spoken” from the unit via voice synthesizer. The device converts an analog signal (e.g., of an environmental factor, e.g., temperature) to digital data that is acted on by microprocessor, which provides the user with the desired environmental characteristic by either touch of a button or by voice recognition. The device may include different types of (analog or digital) sensors to provide other environmental characteristics (e.g., humidity). By speaking the characteristic(s), a sight-impaired and/or elderly person can learn about information and conditions of their environment, with a touch of the button, or by automatically geneating information at time intervals set by with microprocessor. In one operable example, the device is used by a camper that is concerned about freezing temperatures; the device provides an audible alarm when the device experiences freezing conditions.

The following patents are incorporated herein by reference, for background and disclosure purposes:

| | | |
|---|---|---|
| 4428685 | October 1980 | Lemelson, et al. |
| 3453546 | July 1969 | Fryer |
| 3683346 | August 1972 | Horton |
| 3817105 | June 1974 | Luhowy |
| 3822598 | July 1974 | Brothers, et al. |
| 3870818 | March 1975 | Barton, et al. |
| 3903471 | September 1975 | Hiraga, et al. |
| 3922716 | November 1975 | Arnold, et al. |
| 3972237 | August 1976 | Turner |
| 4000489 | December 1976 | Bench |
| 4125023 | November 1978 | Amemiya, et al. |
| 4161880 | July 1979 | Prosky |
| 4199986 | April 1980 | Ganslmeier, et al. |
| 4277975 | July 1981 | Pinkham |
| 4278970 | July 1981 | Streczyn, et al. |
| 4308465 | December 1981 | Lafuze |
| 4348650 | September 1982 | Tsuzuki, et al. |

### BRIEF DESCRIPTION OF THE DRAWINGS

FIG. 1 shows front and back views of one talking personal environmental status device; and

FIG. 2 shows a block schematic of electronics of the device of FIG. 1.

### DETAILED DESCRIPTION OF THE TALKING PERSONAL ENVIRONMENTAL STATUS DEVICE

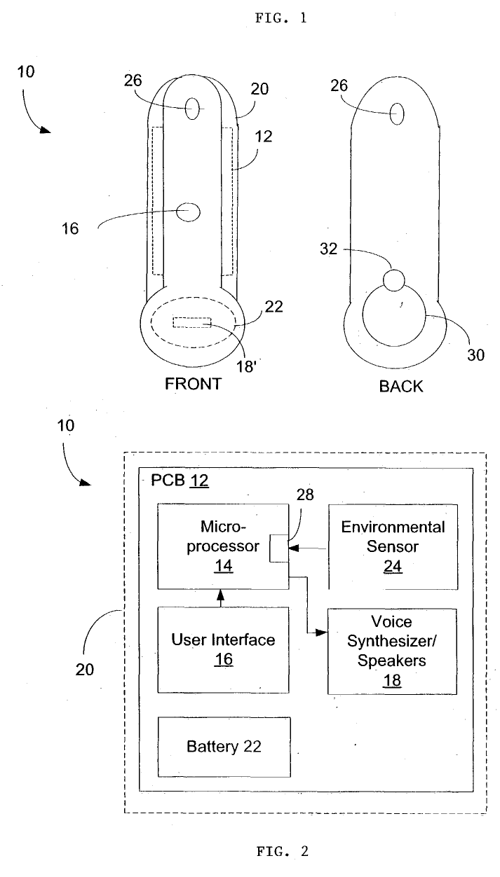

The talking personal environmental status device 10 of FIG. 1 and FIG. 2 contains a printed circuit board (PCB) 12, microprocessor 14, user interface (e.g., buttons) 16, voice synthesizer and/or speaker 18 (emitting sound through speaker holes 18′), enclosure 20 (optionally waterproofed), battery 22 (e.g., lithium battery for cold weather operation), and environmental sensor 24. A hole 26 formed in enclosure 20 is useful (and optional) for attachment to a ring for to facilitate furtther attachment to clothing, jackets, zippers, backpacks, suitcases, handheld baggage, golf bags, sporting equipment bags, toolboxes, etc., or to facilitate placment on a hook to monitor a particular environment.

In operation, sensor 26 produces data indicative of the environmental characteristic to microprocessor 14 (typically through an A/D converter 28, discussed below). Microprocessor 14 processes the data and, in turn, instructs voice synthesizer 28 to emit audible sound to “speak” the environmental characteristic through its speaker. Battery 22 powers device 10.

In one embodiment, sensor 24 is an analog sensor (e.g., a thermocouple or thermistor) that passes its voltage data to an analog to digital converter 28 to provide microprocessor 14 with digital data to evaluate and provide voice synthesis information, with the appropriate vocabulary for the type of environment to be announced to the user of device 10. Limits may be set (e.g., temperature limits, like “freezing”) to alert the user to any condition that the various different types of sensors can sense.

In one embodiment, on the back of device 10, a battery access port 30 is provided, with a latch 32 to open and reinstall a new battery 22.

An A/D converter is not necessary if for example sensor 24 is a digital sensor. Sensor 24 may include one or more sensors to monitor: temperature, humidity, wind, barometric pressure, wind-chill, UV radiation, x-ray radiation, carbon monoxide, radon gas, dust particles, and/or other environmental characteristics.

Device 10 is typically small and lightweight, weighing less than 50 grams (and preferably less than 10 grams) so as to be carried around easily by a human without noticeable weight.

What is claimed is:

1. A talking personal environmental status device, comprising a watertight enclosure, environmental sensor, a voice synthesizer, battery, speaker, and microprocessor, the environmental sensor generating a signal indicative of an environmental characteristic, the microprocessor processing the signal to instruct the voice synthesizer to emit sound from the speaker and audibly speak the environmental characteristic.

2. The device of claim 1, the microprocessor, batter, voice synthesizer being integrated with a PCB.

3. The device of claim 1, further comprising an A/D converter for converting the signal to digital data for the microprocessor.

4. The device of claim 1, the sensor comprising one or more of a temperature and humidity sensor.

5. The device of claim 1, the sensor comprising one or more of a temperature and humidity sensor.

6. The device of claim 1, the sensor comprising a barometric pressure sensor.

7. The device of claim 1, the sensor comprising a wind chill sensor.

8. The device of claim 1, the sensor comprising a wind speed sensor.

9. The device of claim 1, the sensor comprising a UV sensor.

10. The device of claim 1, the sensor comprising a carbon monoxide sensor.

11. The device of claim 1, the sensor comprising a radon sensor.

12. The device of claim 1, the sensor comprising a dust particle sensor.

13. The device of claim 1, the sensor automatically emitting the sound of the environmental characteristic at preset time intervals.

14. The device of claim 1, further comprising a button, the sensor automatically emitting the sound of the environmental characteristic in response to pressing the button.
